(19) United States
(12) Patent Application Publication
(10) Pub. No.: US 2009/0312907 A1
(43) Pub. Date: Dec. 17, 2009

(54) METHOD OF CONTROLLING AT LEAST ONE ANTI-ROLL BAR ACTUATOR ON BOARD A VEHICLE

(75) Inventor: Richard Pothin, Jouars Pontchartrain (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 11/913,881

(22) PCT Filed: May 10, 2006
(86) PCT No.: PCT/FR06/50423

§ 371 Date: Apr. 23, 2008

(30) Foreign Application Priority Data
May 10, 2005 (FR) 0504671

(51) Int. Cl. B60G 17/016

(52) U.S. Cl. 701/38

(57) ABSTRACT

A method of controlling at least one anti-roll bar actuator on board a vehicle. The method controls the at least one anti-roll actuator as a function of a measurement of lateral acceleration of the vehicle and controls the vehicle as a function of a value of a static gain in relation to a transfer function between an angle of a vehicle steering control member and a rate of yaw of the vehicle.

The invention relates to the control of motor vehicles and in particular to the control of active anti-roll systems which provide control over the static yaw response of the vehicle.

Nowadays, attempts are being made at improving vehicle behavior and passenger comfort by controlling the yaw behavior of the vehicle, for example in a turn or several consecutive turns.

It is in fact known that vehicles are generally designed to have the most stable behavior possible irrespective of the commands input by the driver or the condition of the roadway. However, certain situations may lead to a loss of control of the vehicle, such as for example a single or double obstacle-avoidance maneuver. Losses of control in such situations are often due to a vehicle response that is inappropriate because it is either too sharp, inadequately damped, or alternatively, not very predictable.

What is more, attempts are being made at improving the feeling of safety as well as driving comfort and enjoyment.

To these ends, motor vehicles provided with active anti-roll bars equipped with actuators are known. Systems such as these may be operated in such a way as to improve, for each vehicle speed, the yaw response of the vehicle following a violent turn of the steering wheel by the driver. A vehicle such as this is disclosed, for example, in document EP-1 304 270.

It is an object of the invention to further improve the control strategies in this area.

To these ends, the invention provides a method of controlling a vehicle, in which at least one anti-roll actuator is controlled as a function of a measurement of a lateral acceleration of the vehicle.

The method according to the invention may also have at least any one of the following features:
control is performed as a function of a longitudinal speed of the vehicle;
a longitudinal speed of the vehicle is determined on the basis of data provided by an antilock braking system;
control is performed as a function of a value of a static gain of a transfer function relating an angle of a steering control of the vehicle and a rate of yaw of the vehicle;
the gain is determined as a function of a longitudinal speed of the vehicle;
the static gain is a reference static gain;
a control value to be input into the or each actuator is determined using a map;
the control value is determined in such a way that it falls between two predetermined limits; and
an anti-roll apportioning factor is determined so that the anti-roll effect can be split between front and rear anti-roll actuators.

The invention also provides a vehicle comprising:
at least one anti-roll actuator; and
a control member,
   designed to control the or each actuator as a function of a measurement of a lateral acceleration of the vehicle.

Other features and advantages of the invention will become further apparent from the following description of a preferred embodiment which is given by way of nonlimiting example with reference to the attached drawings in which:

FIG. 1 is a graph illustrating the change in cornering rigidity of a tire as a function of the vertical load applied to the tire;

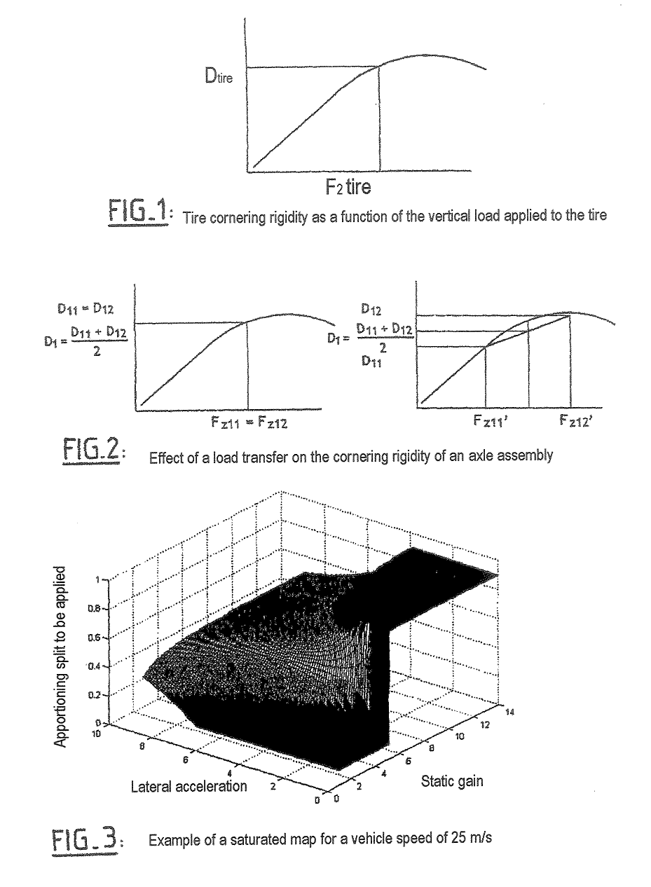

FIG. 2 illustrates, in two graphs, the effects of load transfer on the cornering rigidity of one axle assembly of a vehicle;

FIG. 3 is an example of a saturated map used in the context of the method of the invention, for a given speed;

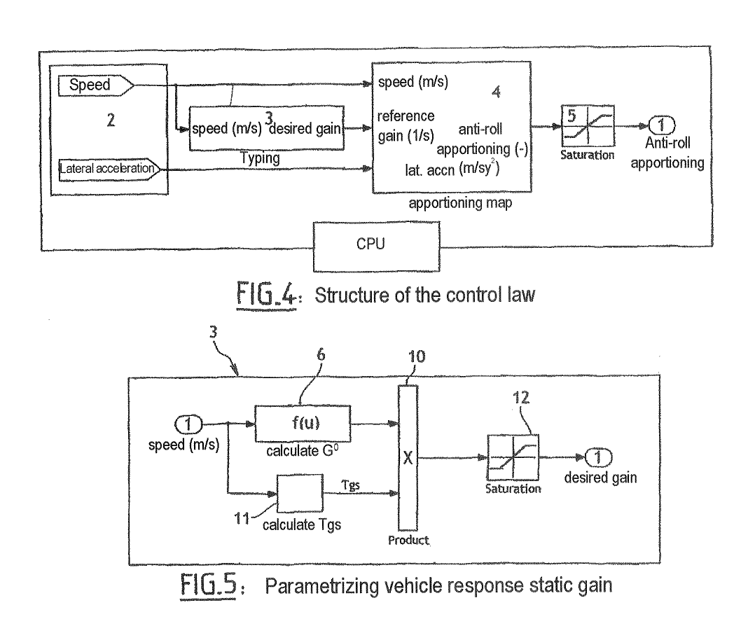

FIG. 4 is a flow diagram showing the general sequence of the method in this embodiment of the invention; and

FIG. 5 illustrates the step of parametrizing the static link in the method of FIG. 4.

A preferred embodiment of the method of the invention will be described hereinbelow.

The method is implemented on a four-wheeled motor vehicle which, at the front and rear, has active anti-roll bars associated with actuators so that the rigidity can be altered and controlled. The bars in the actuators are of a type known per se. The vehicle comprises a central processing unit able to control various parts of the vehicle including the actuators associated with the anti-roll bars.

The theory on which the method implemented is based will first of all be set out. The following notations will be used:
M (kg): total mass of the vehicle
I_{zz} (kg·m2): inertia of the body of the vehicle about a vertical axis passing through its center of gravity
L (m): vehicle wheelbase
L₁ (m): distance between the center of gravity and the front axle
L₂ (m): distance between the center of gravity and the rear axle
E₁ (m): track of the front axle, i.e. distance between the two front wheels
E₂(m): track of the rear axle
h (m): height of the center of gravity with respect to the ground
α₁ (rad): front wheel steering angle, i.e. angle made by the front wheels with respect to the longitudinal axis of the vehicle
V (m/s): vehicle speed
γ_{T} (m/s²) lateral acceleration experienced by the vehicle at the center of gravity
\dot{ψ} (rad/s): rate of yaw of the vehicle
D₁, D₂: cornering rigidities of the front and rear axle assemblies
D₁₁, D₁₂: cornering rigidities of the front left and front right tires
F_{Z,front}, F_{z,rear}: vertical load on the front and rear tires in the absence of lateral acceleration
ΔF_{z,front}, ΔF_{z,rear}: load transfers on the front and rear axles
K_{θ1}, K_{θ2} (N·m/rad): roll stiffness of the front and rear axle assemblies
k(−): anti-roll action split.

Let us start by considering the transfer function relating the steering angle of the wheels, α₁, and the rate of yaw of the vehicle, \dot{ψ}:

$$\frac{\dot{ψ}}{{α}_{1}} = \frac{{K}_{0} \cdot ( 1 + {τ}_{1} s )}{{s}^{2} + 2 \cdot ξ \cdot {ω}_{n} s + {ω}_{n}^{2}} \qquad ( 1 )$$

The characteristics of this transfer function are dependent on the parameters of the vehicle:

$${K}_{0} = \frac{{D}_{1} {D}_{2} L}{{MVI}_{zz}}$$

$${τ}_{1} = \frac{{MVL}_{1}}{{D}_{2} L}$$

$${ω}_{n} = \sqrt{\frac{{MV}^{2} ( {D}_{2} {L}_{2} - {D}_{1} {L}_{1} ) + {D}_{1} {D}_{2} {L}^{2}}{{MV}^{2} {I}_{zz}}}$$

$$ξ = \frac{1}{2} ( \begin{matrix}M ( {D}_{1} {L}_{1}^{2} + {D}_{2} {L}_{2}^{2} ) + \\ {I}_{zz} ( {D}_{1} + {D}_{2} )\end{matrix} ) \cdot \sqrt{\frac{1}{{MI}_{zz} ( \begin{matrix}{MV}^{2} ( {D}_{2} {L}_{2} - {D}_{1} {L}_{1} ) + \\ {D}_{1} {D}_{2} {L}^{2}\end{matrix} )}}$$

We shall be concerned most particularly with the static gain of this transfer function:

$${G}_{0} = \frac{{K}_{0}}{{ω}_{n}^{2}} = \frac{{D}_{1} {D}_{2} LV}{{MV}^{2} ( {D}_{2} {L}_{2} - {D}_{1} {L}_{1} ) + {D}_{1} {D}_{2} {L}^{2}} \qquad ( 2 )$$

It can be seen that this static gain G₀ is directly dependent on the cornering rigidities of the axle assemblies, D₁ and D₂. It will be demonstrated that the anti-roll split makes it possible to alter the cornering rigidities and therefore to alter the static yaw response of the vehicle.

Let us define the anti-roll stiffness split:

$$k = \frac{{K}_{θ 2}}{{K}_{θ 1} + {K}_{θ 2}}$$

The transfers of load to the front or to the rear can be expressed as a function of k and of the lateral acceleration γ_{T}:

$$\begin{matrix}Δ {F}_{Z , front} = \frac{2 \cdot ( 1 - k ) \cdot h \cdot M {γ}_{T}}{{E}_{1}} = {g}_{1} ( k , {γ}_{T} ) & ( 3 ) \\ Δ {F}_{Z , rear} = \frac{2 \cdot k \cdot h \cdot M {γ}_{T}}{{E}_{2}} = {g}_{2} ( k , {γ}_{T} ) & ( 4 )\end{matrix}$$

Furthermore, the cornering rigidities of each tire are dependent on the vertical load applied to the tire. The curve is non-linear and an example of it is given in FIG. 1. This curve can be approximated for example using a polynomial expression.

The rigidity of an axle assembly is obtained by summing the rigidities of the two tires of the axle assembly.

Thus, if the axle assembly is subjected to a load transfer, its rigidity will be altered as a result. In FIG. 2, the left-hand portion shows a situation with no load transfer and the right-hand portion shows a situation where there is load transfer.

Expressed more formally:

$$\begin{matrix}{D}_{1} = ( 1 / 2 ) ⋆ [ \begin{matrix}f ( \frac{{F}_{Z , front}}{2} + \frac{Δ {F}_{Z , front}}{2} ) + \\ f ( \frac{{F}_{Z , front}}{2} + \frac{Δ {F}_{Z , front}}{2} )\end{matrix} ] = {f}^{1} ( Δ {F}_{Z , front} ) & ( 5 ) \\ {D}_{2} = ( 1 / 2 ) ⋆ [ \begin{matrix}f ( \frac{{F}_{Z , rear}}{2} + \frac{Δ {F}_{Z , rear}}{2} ) + \\ f ( \frac{{F}_{Z , rear}}{2} + \frac{Δ {F}_{Z , rear}}{2} )\end{matrix} ] = {f}^{1} ( Δ {F}_{Z , rear} ) & ( 6 )\end{matrix}$$

Substituting expressions (3) and (4) into (5) and (6) gives:

D₁=f¹(ΔF_{Z,front})=f¹(g₁(k,γ_{T}))=D₁(k,γ_{T}) (7)

D₂=f¹(ΔF_{Z,rear})=f¹(g₂(k,γ_{T}))=D₂(k,γ_{T}) (8)

And finally, substituting (7) and (8) into (2) yields:

G₀=G₀(D₁(k,γ_{T}),D₂(k,γ_{T}),V)=G₀(k,γ_{T},V)

This then produces a relationship expressing the influence that the lateral acceleration, the speed and, above all, the anti-roll split has on the static response of the vehicle. This relationship can then be reversed in order to obtain the anti-roll split to be applied in order to achieve the desired static gain G_{0,d} (for the transfer function (1)), when the lateral acceleration γ_{T} and the vehicle speed V are known:

k=k(G_{0,d},γ_{T},V) (9)

This then gives a control that can be used to control the static response of the vehicle as a function of the situation, i.e. as a function of the lateral acceleration γ_{T} and of the speed V of the vehicle.

After that, it is then necessary to saturate this control in such a way that the values can be applied. This is because since the apportioning is done using active anti-roll bars, the suspension springs also contribute to the roll stiffness of the vehicle and the split of this stiffness. It is therefore not possible to achieve the extreme values close to the splits k=0 (no roll stiffness at the rear) or k=1 (no roll stiffness at the front). Steps will therefore be taken to saturate the controlled split, for example between 0.1 and 0.9. In other words, if the calculated value k exceeds 0.9, it will be brought down to 0.9. Conversely, if it is below 0.1, it will be raised to 0.1.

The control principle lies in expression (9). All the calculations to obtain this expression can be developed analytically. It is also possible to carry out numerical calculations for a great many values of G_{0,d}, γ_{T} and V. This then yields a map with three input dimensions (speed, lateral acceleration and static gain) and makes it possible to obtain along the vertical axis z the control k that is to be applied. An example of such a map for a given speed of 25 m/s is depicted in FIG. 3. The map depicted has been saturated between 0.1 and 0.9 in accordance with the explanations given above.

Furthermore, implementation of the control using this type of map is depicted in FIG. 4.

The control strategy that allows the typing of the static yaw response of the vehicle is integrated into the central processing unit of the vehicle as illustrated in FIG. 4.

The block diagram of FIG. 4 has been broken down into four parts:
the input signals (block 2);
the parametrizing of the static gain of the response of the vehicle (block 3);
the mapping of gains for calculating the control (block 4);
saturation of the control (block 5).

In block 2 which corresponds to the input signals, the control requires the following measurements or signals:
the longitudinal speed of the vehicle: this signal is, for example, obtained by calculating the mean speed provided by antilock braking systems (ABS) in respect of the wheels of one axle;
the lateral acceleration experienced by the vehicle: this signal may, for example, be obtained using a sensor of the accelerometer type.

The static gain of the response of the vehicle is parameterized in block 3. FIG. 5 provides details of block 3. This block calculates the desired static gain as a function of the longitudinal speed V of the vehicle as indicated in block 6. To do this, it uses the static gain of the transfer function relating the steering wheel angle and the rate of yaw. As a reminder, this static gain can be written as follows:

$${G}_{0} = \frac{{D}_{1} {D}_{2} LV}{{MV}^{2} ( {D}_{2} {L}_{2} - {D}_{1} {L}_{1} ) + {D}_{1} {D}_{2} {L}^{2}}$$

This expression represents the reference static response of the vehicle and can be calculated as a function of the vehicle's speed.

Next, as illustrated in block 10, this starting static gain is multiplied directly by a typing signal Tgs. Thus, the desired static gain G_{0,d} will be directly equal to Tgs×G₀ and will obey a predetermined rule such that:
if Tgs is equal to 1, the vehicle behavior will remain unchanged,
if Tgs is greater than 1, the static response of the vehicle is increased,
if Tgs is less than 1, the static response of the vehicle is decreased.

This parameter Tgs here can vary as a function of the speed of the vehicle. The desired typing of the vehicle will therefore be characterized beforehand using a curve representing the parameter Tgs as a function of the vehicle speed V as illustrated in block 11. Ultimately, this amounts to:

G_{0,d}(V)=G₀(V)·Tgs(V)

The desired static gain obtained will then be saturated in block 12 to avoid demanding excessive and unattainable amounts of control.

In FIG. 4, the gain map is implemented in block 4. This block makes it possible to calculate the anti-roll split to be applied as a function of the longitudinal speed of the vehicle, the lateral acceleration and the desired static gain. This map represents the above expression (9). In reality, this amounts to performing a control of the type:

k=C₀+C₁·V+C₂·γ_{T}+C₃·G_{0,d}

Finally, the control is saturated in block 5. As explained above, this block makes it possible to saturate the controlled anti-roll split to ensure that the anti-roll system remains within applicable limits. The output is simply made to remain between a lower limit and an upper limit.

The invention allows the static yaw responses of a vehicle equipped with an active anti-roll device to be typed as a function of the speed of this vehicle. This invention provides the control law with operates the active anti-roll system and, by virtue of a strategy based on measuring the lateral acceleration, makes it possible to regulate the static yaw response of the vehicle as a result, for example, of a violent turn of the steering wheel. As has been seen, it is incorporated into an overall system the hardware architecture of which comprises at least one controlled anti-roll device, one or more sensors for assessing the lateral acceleration, means for determining the longitudinal speed of the vehicle, and one or more electronic processing means.

The invention offers a strategy for controlling the front-rear split that apportions the action of the active anti-roll bars in order to control the static yaw response of the vehicle.

Finally, the invention offers the following advantages:
the control strategy has a structure based on measuring the lateral acceleration of the vehicle;
the control strategy allows the static part of the lateral response of the vehicle to a violent turn of the steering wheel to be regulated. Final adjustment makes it possible, for example, to optimize low-speed maneuverability;
the control strategy takes account of the speed of the vehicle and reacts differently according to this speed;
the control strategy generates an anti-roll apportioning reference so that it can be applied by an anti-roll actuator, such as controllable anti-roll bars for example on each axle of the vehicle;
saturating the control allows this control to be kept within limits such that it can actually be applied by the actuator;
the control strategy does not use any rate of yaw sensor, thus limiting the cost and complexity of the system;
the control strategy can act as an emergency backup system for other lateral control systems that use a yaw rate sensor, such as the ESP (the acronym for Electronic Stability Program) for example; and
the strategy can be developed easily and intuitively because the controlling parameter is associated with the nominal performance of the vehicle. A controlling parameter equal to “1” does not alter the behavior of the vehicle, whereas a parameter greater (or less than) “1” makes the behavior more (or less) direct.

Of course, numerous modifications may be made to the invention without departing from the scope thereof.

1-9. (canceled)

10. A method of controlling a vehicle, comprising:
controlling at least one anti-roll actuator as a function of a measurement of a lateral acceleration of the vehicle; and
performing the controlling as a function of a value of a static gain of a transfer function in relation to an angle of a steering control of the vehicle and a rate of yaw of the vehicle.

11. The method as claimed in claim 10, wherein the controlling is performed as a function of a longitudinal speed of the vehicle.

12. The method as claimed in claim 10, further comprising determining a longitudinal speed of the vehicle based on data provided by an antilock braking system.

13. The method as claimed in claim 10, further comprising determining the static gain as a function of a longitudinal speed of the vehicle.

14. The method as claimed in claim 10, wherein the static gain is a reference static gain.

15. The method as claimed in claim 10, further comprising determining a control value to be input into the at least one actuator using a map.

16. The method as claimed in claim 15, wherein the control value is determined such that the control value falls between two predetermined limits.

17. The method as claimed in claim 10, further comprising determining an anti-roll apportioning factor so that an anti-roll effect can be split between front and rear anti-roll actuators.

18. A vehicle comprising:
at least one anti-roll actuator; and
a control member,
wherein the control member is configured to control the at least one actuator as a function of a measurement of a lateral acceleration of the vehicle, and as a function of a value of a static gain of a transfer function in relation to an angle of a steering control of the vehicle and a rate of yaw of the vehicle.
